(19) United States
(12) Patent Application Publication
(10) Pub. No.: US 2010/0027050 A1
(43) Pub. Date: Feb. 4, 2010

(54) DYNAMIC BRIDGING OF WEB-ENABLED COMPONENTS

(76) Inventor: Alain Regnier, Sunnyvale, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/181,612

(22) Filed: Jul. 29, 2008

(51) Int. Cl. G06F 3/12

(52) U.S. Cl. 358/1.15

(57) ABSTRACT

In an embodiment, a data processing method comprises receiving and storing a set of associations each identifying two or more data processing components and one or more associated actions; receiving a combination of an association and an action that can be performed on the association comprising a first data processing operation and a second data processing operation; generating and sending, over a network, to a first component that implements the first data processing operation, a first request to perform the first data processing operation; receiving result data from the first component; generating and sending, over the network, to a second component that implements the second data processing operation, a second request to perform the second data processing operation using the result data.

### TECHNICAL FIELD

The present disclosure generally relates to data processing. The disclosure relates more specifically to techniques for causing remote devices or services to interact with one another remotely.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In some computer networks, client computers can send documents to printing devices, receive messages containing scanned documents from scanners and multifunction printers (MFPs), and cause other remote devices to perform other tasks. However, current technology does not permit the remote devices to interact with one another remotely to perform groups of tasks.

### SUMMARY OF THE DISCLOSURE

In an embodiment, a data processing method comprises in combination receiving and storing a set of associations each identifying two or more Web Services Device enabled (WSD-enabled) data processing devices and one or more actions each comprising two or more device operations; sending a discovery message to a network interface, wherein the discovery message identifies one or more service types, wherein the discovery message requests Web Services devices in the network to reply if the devices implement any of the service types; receiving, from one or more Web Services devices that implement a Device Control Protocol (DCP), one or more discovery response messages that identify particular service types that are implemented; generating output presenting a list of available associations based on the list of association definitions, the discovery response messages and operations associated with the service types; receiving a combination of an association and an action that can be performed on the association comprising at least a first data processing operation and a second data processing operation; generating and sending, over a network, to a first device that implements the first data processing operation, a first request to perform the first data processing operation; receiving result data from the first device; generating and sending, over the network, to a second device that implements the second data processing operation, a second request to perform the second data processing operation using the result data, wherein sending the first request and sending the second request each result in performing one or more of printing data, scanning data, transferring data over the network to a server, or transforming data from a first format to a second format; updating the output in response to receiving a completion message indicating completion of the second data processing operation.

In an embodiment, a data processing method comprises receiving and storing a set of associations each identifying two or more data processing components and one or more associated actions; receiving a combination of a particular association from among the set and a particular action comprising a first data processing operation and a second data processing operation; generating and sending, over a network, to a first component that implements the first data processing operation, a first request to perform the first data processing operation; receiving result data from the first component; generating and sending, over the network, to a second component that implements the second data processing operation, a second request to perform the second data processing operation using the result data.

For example, a given association, such as SCAN SERVICE/PRINT SERVICE can have different actions that can be performed on it, such as a “Scan then print” action or a “Print list of scanned documents” action. In an embodiment, the association of “SCAN SERVICE/PRINT SERVICE” may be received in combination with one of the actions, such as “Scan then print.”

In an embodiment, sending the first request and sending the second request each result in performing one or more of printing data, scanning data, transferring data over the network to a server, or transforming data from a first format to a second format.

In an embodiment, the method further comprises sending a discovery message to a network interface, wherein the discovery message identifies one or more service types, wherein the discovery message requests any components in the network to reply if the components support any of the one or more service types; receiving one or more discovery response messages that indicate that one or more of the service types are implemented; identifying one or more particular operations that are associated with the service types in the discovery response messages, and determining one or more available associations having actions that are associated with the one or more particular operations; generating output presenting a list of the available associations.

In an embodiment, the method further comprises generating a graphical user interface presenting the list of available associations, and updating the graphical user interface in response to receiving a completion message indicating completion of the second data processing operation. In an embodiment, the method further comprises receiving the set of associations from any one of: a computer that comprises the computer-readable storage medium; a multifunction printer; a server that is coupled over a network to a computer that comprises the computer-readable storage medium; and an internet gateway component that is coupled to a computer that comprises the computer-readable storage medium.

In an embodiment, the method further comprising instructions which when executed cause receiving and storing a set of component associations, wherein each member of the set is any one of: Scanner-Printer: scan then print; Scanner-Printer: print list of scanned documents; TV-Printer: print electronic program guide; Camera-Web Site: transfer pictures to online web site; Camera-Printer: print list of images with thumbnails; Storage Component-Printer: print document from storage component. The set members enumerated in the preceding sentence merely represent some examples, and other combinations may be used in various embodiments.

The functions summarized in this section also may be implemented, in various embodiments, in computers such as workstations, personal computers, handheld computers, personal digital assistants (PDAs), cellular radiotelephones, and other computing devices, as well as in one or more computer programs or other software elements that are stored in or carried on non-volatile or volatile computer-readable media.

All steps described herein as method steps may be implemented, in various embodiments, as computer-implemented steps or program steps performed by a programmed computer. Certain steps may be performed in an order different than the order that is illustrated in the drawings and described herein.

### BRIEF DESCRIPTION OF DRAWINGS

In the drawings:

FIG. 1 illustrates an example plurality of web-enabled components that may interact remotely based on a stored set of associations.

FIG. 2 illustrates an example software architecture of a web-enabled component.

FIG. 3 illustrates a process of remote devices interacting remotely.

FIG. 4 illustrates an example user interface for a client computer component.

FIG. 5 illustrates a general-purpose computer system on which an embodiment may be implemented.

### DESCRIPTION OF EXAMPLE EMBODIMENTS

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Device Profile for Web Services (DPWS), formerly known as Web Services for Devices (WSD), is a Web Services device control specification that is intended to provide discovery, control, event processing and usability functions for networked computer peripheral devices. It is based on other Web Services specifications such as WS-Addressing, WS-Discovery, WS-Eventing, and WS-MetadataExchange. A similar technology not based on Web Services is Universal Plug-n-Play (UPnP).

Example devices include printers, multifunction printing (MFP) devices, scanners, cameras, and others. Each device can provide some form of service to a computer or to another device. For example, a WSD-enabled MFP device might be able to provide a Print service, a Scan service and a Fax service. A WS-enabled device can be accessed and used, using Web Services messages, communicated from a client computer that supports Web Services, such as a personal computer running Microsoft Windows Vista. Each WSD-enabled device has the following characteristics: Address; Description; Services List; WSDL file defining an available application programming interface (API); List of events to which a client computer can subscribe.

Device Control Protocol (DCP) provides a way to specify services that networked devices can provide. DCPs are equivalent to service types. Each DCP or service type may define several data processing operations. For example, the PRINT DCP defines “Print,” “Show List Jobs,” Show Ink Level,” and other operations.

In an embodiment, a remote client computer can discover available services on the network, choose a combination of an association of services and an action that defines which operation(s) of each service should be performed in sequence, such as a first operation and one or more second and successive operations, perform the selected action including all associated operations on one or more available devices, and display a result to the user through the remote client computer. For example, two services may be denoted Service A and Service B, and an action may comprise an association indicating to perform Operation 1 on Service A, then Operation 2 on Service B using the results of Operation 1 on Service A. Thus, an action is a combination of several operations from several devices implementing various service types or DCPs, as defined in an association. As a result, embodiments can enable interactions between services of different types to enable rich client computer-device data processing and operational scenarios. Automation can be improved and a user is not required to manually transfer data, generated by a first device or resulting from a first service, to a second device.

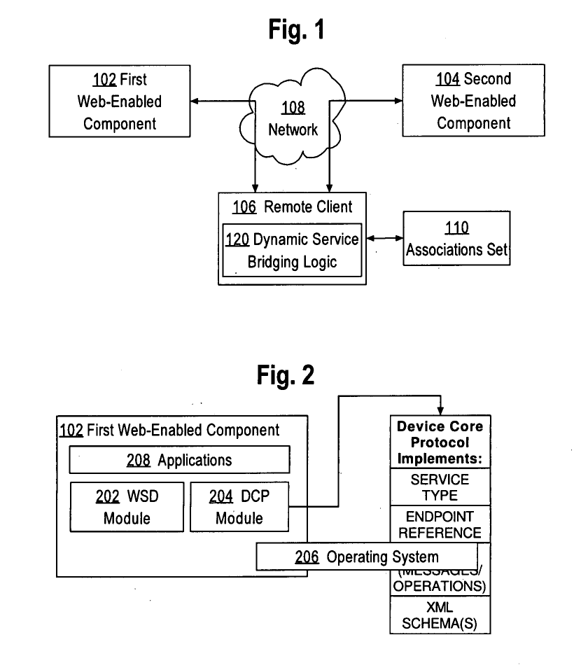

FIG. 1 illustrates an example plurality of web-enabled components that may interact remotely based on a stored set of associations. In this context, “web-enabled” means that a component has an HTTP server, is able to be discovered as a service, and can provide information about or a list of operations that could be executed using the component or a device in which it is hosted. A first web-enabled component 102 and a second web-enabled component 104 are coupled to a network 108. Each of the components 102, 104 may comprise a computer peripheral device of any type, including but not limited to a printer, scanner, MFP, camera, etc. Each of the components also may comprise a computer process hosted on a general-purpose computer. The components 102, 104 may be in different physical or geographic locations.

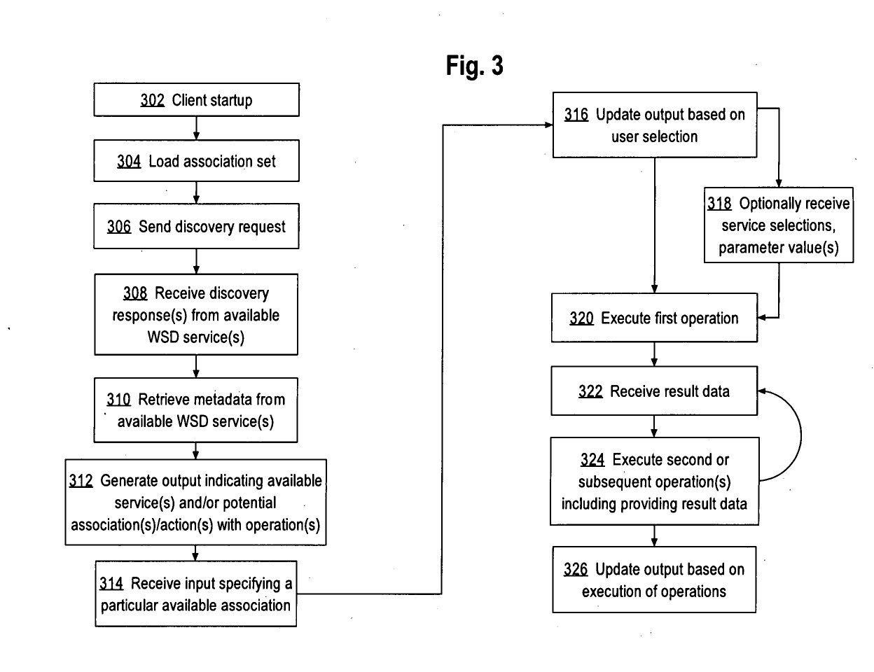

A remote client 106 is coupled to network 108. The remote client 106 may comprise a computer, a peripheral device of any type including the peripheral devices identified in the preceding paragraph, a computer process hosted on a general-purpose computer, or a web-enabled component. In various embodiments, remote client 106 may comprise an iPhone, cellular radiotelephone, or a personal digital assistant (PDA) such as a BlackBerry device. The remote client also may comprise a television having a processor, non-volatile and volatile memory, user interface, remote control, etc. In an embodiment, remote client 106 hosts dynamic service bridging logic 120 and is coupled to or can access an associations set 110 as shown in FIG. 1. In an embodiment, dynamic service bridging logic 120 comprises one or more computer programs or other software elements hosted in remote client 106 that implement the functions described further herein, such as the functions of FIG. 3.

In an embodiment, the associations set 110 comprises stored data that associates two or more services or DCPs with one another, and associates an action comprising one or more operations of each service or DCP. The associations set 110 may be stored in any convenient location in the networked environment shown in FIG. 1. For example, associations set 110 may be stored in any of the following: storage local to remote client 106, such as a hard disk on a client computer, such as a pre-configured data file that is bundled with the dynamic service bridging logic 120; a web server or content server that is coupled to network 108; any of the components 102, 104; another web-enabled component; a server on a local area network (LAN) to which the remote client 106 is coupled or accessible.

TABLE 1 provides examples of information that can be included in association set 110.

TABLE 1

| | Action and Associated | | Second | |
|---|---|---|---|---|
| Association | Operations | First Service Type | Service Type | Client Type |
| Scanner-Printer | Scan then Print | Scan DCP | Print DCP | Computer |
| Scanner-Printer | Print list of scanned | Scan DCP | Print DCP | Computer |
| | documents | | | |
| TV-Printer | Print electronic | TV DCP | Print DCP | Cellular |
| | program guide | | | Phone |
| Camera-Web Site | Transfer pictures to | Camera DCP | Photo Gallery | Computer |
| | online web side | | DCP | |
| Camera-Printer | Print list with | Camera DCP | Print DCP | Computer |
| | thumbnails | | | |
| Document | Print document from | Document | Print DCP | Cellular |
| Repository-Printer | repository | Repository DCP | | Phone |

FIG. 2 illustrates an example software architecture of a web-enabled component. In an embodiment, the first web-enabled component 102 hosts or comprises an operating system 206, WSD module 202, DCP module 204, and one or more applications 208. The operating system 206 supervises operation of other elements of the system and controls input/output elements, if any, of the web-enabled component. The WSD module 202 comprises one or more computer programs or other software components that implement Web Services specifications. The DCP module 204 comprises one or more computer programs or other software components that implement Device Control Protocol. The applications 208 implement device-specific functions such as printing control, scanning control, or other applications.

DCP module 204 comprises, in one embodiment, one or more stored data items that indicate one or more DCPs or service types, an endpoint reference, WSDL data, and one or more XML schema(s). The service type indicates a type of service that is provided by the component such as Print, Scan, Photo Repository, etc. The endpoint reference, in one embodiment, is a uniform resource locator (URL) to which SOAP messages may be directed to communicate to the component. The WSDL data comprises a list of available messages or operations that the component can process. The XML schema(s) comprise data structures defining physical or logical attributes of a component, such as the number of paper trays, type of paper supported in the paper trays, features supported, etc. The DCP module 204 also comprises logic to actually implement the DCP or service type that is described in the metadata identified above.

Collectively the data items of the DCP module 204 define an interface that is addressable by the remote client 106, the second web-enabled component 104, or other compatible components, such as other web-enabled computers. Thus, in one embodiment, a component implements the Web Services Device specification, using WSD module 202, for example. In this embodiment, components 102, 104 communicate with remote client 106 through network 108 using SOAP messages. However, other embodiments may be web-enabled without using WSD or Web Services. For example, a web-enabled component may implement Universal Plug-n-Play (UPnP) with DCP.

FIG. 3 illustrates a process of remote devices interacting remotely. In an embodiment, the dynamic service bridging logic 120 in remote client 106 implements the process of FIG. 3.

Client startup occurs at operation 302. For example, remote client 106 initiates operation. At operation 304, a set of associations is loaded. In an embodiment, operation 304 involves remote client 106 receiving and storing a set of associations, in which each association in the set identifies one or more data processing actions. The set may comprise one or more associations each identifying two or more Web Services-enabled data processing devices and one or more actions, and each of the actions may comprise a combination of one or more operations of one or more devices implementing various service types or DCPs. In various embodiments, operation 304 involves dynamic service bridging logic 120 loading the associations set 110 from any of the following: storage local to remote client 106, such as a hard disk on a client computer, such as a pre-configured data file that is bundled with the dynamic service bridging logic 120; a web server or content server that is coupled to network 108; any of the components 102, 104; another web-enabled component; a server on a local area network (LAN) to which the remote client 106 is coupled or accessible; a multifunction printer; an internet gateway component that is coupled to a computer that implements FIG. 1.

When the associations set 110 is loaded from an element other than remote client 106, the remote client may store the associations set in local storage, such as main memory or in local non-volatile storage.

In operation 306, a discovery request is sent. In an embodiment, operation 306 comprises remote client 106 multicasting or otherwise sending a discovery message to a network interface; the discovery message identifies one or more DCPs or service types, and requests Web Services devices coupled to the network 108 to reply if the devices support or implement the DCPs or service types. In one embodiment, Web Services messages under the WS-Discovery specification may be used. In other embodiments, discovery mechanisms other than WS-Discovery may be used, such as SSDP.

In operation 308, discovery response(s) are received from available WSD service(s).

In one embodiment, operation 308 comprises receiving, from one or more Web Services devices that implement a Device Control Protocol (DCP), one or more discovery response messages that identify service types or DCPs that the devices support. Using the discovery process, for example, the dynamic service bridging logic 120 can verify that services identified in the associations set 110 are actually available in the network 108 from devices that are online and responsive.

In operation 310, metadata is retrieved from the available WSD services. For example, the dynamic service bridging logic 120 of remote client 106 retrieves, for each service, service type, endpoint reference, WSDL messages or operations, and one or more XML schema(s). The data items are retrieved from the Web Services device or component that sent a discovery response message indicating that a particular service type is implemented.

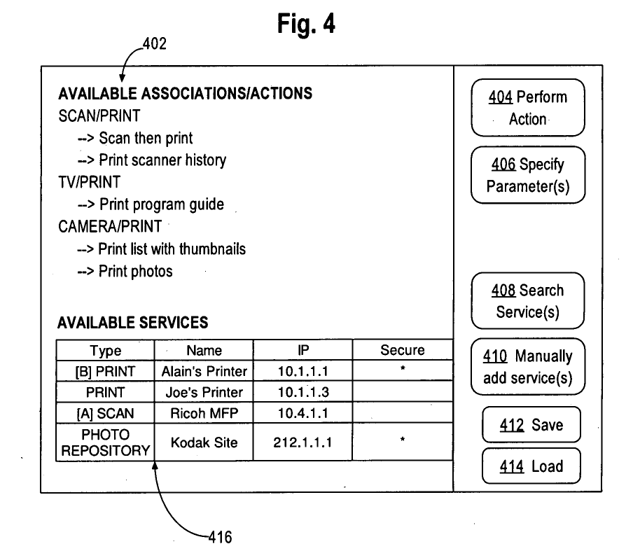

In operation 312, output is generated indicating one or more available services and/or potential associations or actions. The output may present a list of available associations based on the discovery response messages. As part of operation 312, the process identifies one or more particular operations that are associated with the service types in the discovery response messages, and determines one or more available associations that identify actions that include the one or more particular operations. The output may comprise a message, report, log record or log file, or graphical display. For example, the dynamic service bridging logic 120 of remote client 106 generates a graphical user interface for a display device of the remote client that shows available services, associations or actions. The example graphical user interface of FIG. 4 may be used. The output may be generated according to the display capabilities of the remote client 106 and may comprise character-based output, a miniature GUI on a PDA, text output on a liquid crystal display (LCD) or light-emitting diode (LED) display of an MFP, etc. The specific form of the output is not critical.

In operation 314, input specifying a particular available association is received. In an embodiment, operation 314 comprises receiving a selection of a particular association from among the set, and the particular association identifies a first data processing operation and a second data processing operation. Operation 314 may involve receiving user input through the graphical user interface of FIG. 4, other output, or other interface as appropriate.

In operation 316, the output is updated based on the user selection. For example, the output is updated to indicate that a particular association was selected by the user, using highlighting, color, icons, characters, symbols, or other indications.

In operation 318, the process optionally receives service selections and parameter values as input. For example, an association might identify an MFP device, which provides multiple services including scanning and printing, and a printing device that provides only printing. User input may specify the scanning service of the MFP device. Additionally or alternatively, operation 318 may comprise receiving one or more particular parameter values for a service, such as number of copies to print, output tray, finishing options, scanning options such as resolution, color or black-and-white scanning, grayscale, output file type, etc. Different services may support different parameter values and the particular kind of parameter values that are provided is not critical.

In operation 320, a first operation specified in the association is executed. In an embodiment, operation 320 comprises generating and sending, over the network, to a first device that implements the first data processing operation, a first request to perform the first data processing operation. For example, the dynamic service bridging logic 120 of remote client 106 generates and sends a Web Services request to the first web-enabled component 102 to perform the first operation. The previously received metadata may be used to generate the request. The request may include data or a payload for use in performing the action, such as a data file, a data file that is formatted in a print control language (PCL), PDL, or PostScript, a set of commands or command-line interface (CLI) instructions, an XML file, or any other data item or data payload that the receiving web-enabled component may use to perform the operation or process the request.

In operation 322, result data is received from the first device. For example, the dynamic service bridging logic 120 of remote client 106 receives a Web Services response message from the first web-enabled component 102 that comprises data that the component created as a result of performing the first operation or processing the request. The response message may include one or more data items, data files, or payloads. For example, the response message may include or comprise an image data file for a document that was scanned on a scanner, an error message, etc.

In operation 324, a second or subsequent operation(s) is/are executed including providing the result data. For example, operation 324 may comprise the dynamic service bridging logic 120 of remote client 106 generating and sending, over the network, to a second device that implements the second data processing operation, a second request to perform the second data processing operation using the result data. The second device may comprise the second web-enabled component 104. Further, sending the first request and sending the second request each may result in performing one or more of printing data, scanning data, transferring data over the network to a server, transforming data from a first format to a second format; or other data processing results.

In various embodiments, operations 322 and 324 may be repeated one or more times in a chain of processing steps that automatically invoke multiple operations of the same or different web-enabled components that implement various service types or DCPs. As a result, a user or process can perform complex document processing scenarios in which data or documents are automatically pipelined or chained among multiple different services, for example, with each successive service receiving result data generated by a prior service.

In operation 326, the output is updated based on execution of the operations. For example, the graphical user interface is updated to indicate completion, what occurred, where documents are located, etc. Operation 326 may be triggered by a message from one of the web-enabled components. Thus, in an embodiment, operation 326 comprises updating the output in response to receiving a completion message indicating completion of the second data processing operation.

FIG. 4 illustrates an example user interface for a client computer component. In the embodiment of FIG. 4, a graphical user interface comprises a first list 402 of available associations and actions, a second list 416 of available services, and functional buttons 404, 406, 408, 410, 412, 414. In an embodiment, the first list 402 comprises a hierarchical list of available associations and actions in which specific actions are listed hierarchically below more names of associations. For example, “SCAN/PRINT” is an association that includes a first action of “Scan then print” and a second action of “Print scanner history”. Each of the actions in an association may involve one or more operations as defined by a particular service type of DCP in a WSD-enabled component. For example, the “Scan then print” action comprises a “scan” operation followed by a “print” operation; the “Print scanner history” action may involve a “get scanned jobs” operation of the SCAN service followed by a “print” operation of the PRINT service.

In an embodiment, the second list 416 of available services identifies particular web-enabled components or devices that are actually available to provide services compatible with one or more of the actions in the first list. For example, second list 416 indicates that devices named Alain's Printer, Joe's Printer, Ricoh MFP, and Kodak Site are available in the network. In an embodiment, list 416 indicates the type of service, name of device or component, address of device or component, and whether the particular service is secure. The type of service may be defined in the metadata of the device or component, such as the Service Type value in the data of DCP Module 204, and typically matches at least a portion of an association in the first list. Thus, the service type value of “PRINT” for the device “Alain's Printer” implicitly means that Alain's Printer implements the PRINT DCP. The name of a device or component may be defined in the DCP. The address of a device or component may comprise a network address obtained by performing a DNS resolution of a URL indicated as the Endpoint Reference in the DCP.

“Secure,” in one embodiment, means that an associated named service can communicate using a secure communications protocol, such as HTTPS (using SSL or TLS over HTTP). Information about support for secure protocols may be obtained from the metadata of the web-enabled component or device, such as the WSDL or XML schema(s) of the DCP Module 204. Knowing that a particular component, device or service can communicate using a secure protocol may be desirable to users in cases when data messages to the component, device or services are required to traverse a public network, so that encryption is desirable or required.

In an embodiment, one or more markers in the second list 416 indicate user-selected services or the order of operations in an action or association. For example, in FIG. 4, the Print service provided by Alain's Printer is designated as [B] and the Scan service provided by Ricoh MFP is designated as [A]. In this example, the “Scan then print” action of the SCAN-PRINT association has been selected, and a scanning operation will be performed first by the Ricoh MFP and then a printing operation will be performed using Alain's Printer. The markers may indicate a sequential order, as [A], [B] indicates according to alphabetical order that the operation marked [A] is first. Numeric, symbolic, or iconic markers may be used in other embodiments.

In an embodiment, the functional buttons 404, 406, 408, 410, 412, 414 comprise a Perform Action button 404, Specify Parameter(s) button 406, Search Service(s) button 408, Manually Add Service(s) button 410, Save button 412, and Load button 414. In an embodiment, selecting the Perform Action button 404 causes the dynamic service bridging logic 120 to execute the operations that have been selected as indicated by the indicators in second list 416. In an embodiment, selecting services may comprise moving a cursor using a pointing device such as a mouse or trackball to one of the types or names shown in second list 416 and activating a selection button.

In an embodiment, selecting the Specify Parameter(s) button 406 causes the dynamic service bridging logic 120 to generate and display one or more user input panels for receiving parameter values for configuring or affecting operation of a particular device or component shown in second list 416. For example, selecting Alain's Printer and then selecting the Specify Parameter(s) button 406 may cause the dynamic service bridging logic 120 to display a pop-up menu that receives values for paper input tray, number of copies, print quality level, etc. The pop-up menu may be constructed according to a form or including particular parameters as defined in the metadata associated with the device. For example, the XML schema(s) of DCP module 204 of a component can define parameter values that a component can accept, and/or the format of a GUI panel for receiving the values.

In an embodiment, selecting Search Service(s) button 408 causes the dynamic service bridging logic 120 to initiate discovery of available services in the network. Thus, in an embodiment, selecting Search Service(s) button 408 causes the dynamic service bridging logic 120 to perform operations 306 to 312, inclusive, of FIG. 3.

In an embodiment, selecting Manually Add Service(s) button 410 causes the dynamic service bridging logic 120 to open one or more input panels for receiving user input to manually add one or more services. For example, the dynamic service bridging logic 120 prompts the user to enter type, name, network address, and security capability data for a service, and then updates second list 416 to identify the manually entered service. In an embodiment, the dynamic service bridging logic 120 also can validate the data by attempting to send one or more WSD messages to the network address identified in the user input. If the specified component or device at that address does not respond or if the address is invalid, an error message can be displayed.

In an embodiment, selecting the Save button 412 causes the dynamic service bridging logic 120 to save the data shown in list 402 and list 416 in local storage. In an embodiment, selecting the Load button 414 causes the dynamic service bridging logic 120 to load an associations set 110 from a specified location and to re-display the user interface including data from the newly loaded associations set. The Load button 414 can invoke a File Open dialog that allows the user to browse in a filesystem to a particular file storage location.

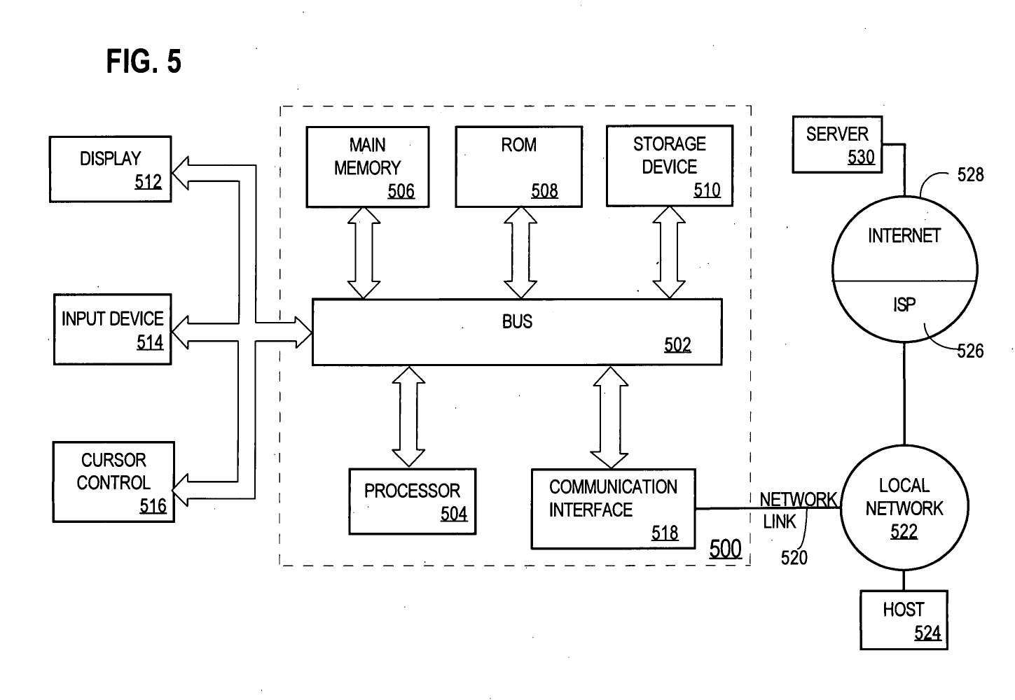

FIG. 5 illustrates a computer system 500 upon which an embodiment of the invention may be implemented.

Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 540 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. For example, applications other than event correlation may use logical topological links in a virtual network to bypass unmanaged segments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-readable storage medium storing in combination sequences of instructions which when executed by one or more processors cause:
receiving and storing a set of associations each identifying two or more data processing components and one or more associated actions;
receiving a combination of an association and an action that can be performed on the association comprising a first data processing operation and a second data processing operation;
generating and sending, over a network, to a first component that implements the first data processing operation, a first request to perform the first data processing operation;
receiving result data from the first component;
generating and sending, over the network, to a second component that implements the second data processing operation, a second request to perform the second data processing operation using the result data.

2. The computer-readable storage medium of claim 1, wherein sending the first request and sending the second request each result in performing one or more of printing data, scanning data, transferring data over the network to a server, or transforming data from a first format to a second format.

3. The computer-readable storage medium of claim 1, further comprising sequences of instructions which when executed cause:
sending a discovery message to a network interface, wherein the discovery message identifies one or more service types, wherein the discovery message requests any components in the network to reply if the components support any of the one or more service types;
receiving one or more discovery response messages that indicate that one or more of the service types are implemented;
identifying one or more particular operations that are associated with the service types in the discovery response messages, and determining one or more available associations that identify actions that include the one or more particular operations;
generating output presenting a list of the available associations.

4. The computer-readable storage medium of claim 3, further comprising instructions which when executed cause generating a graphical user interface presenting the list of available associations, and updating the graphical user interface in response to receiving a completion message indicating completion of the second data processing operation.

5. The computer-readable storage medium of claim 1, further comprising receiving the set of associations from any one of: a computer that comprises the computer-readable storage medium; a multifunction printer; a server that is coupled over a network to a computer that comprises the computer-readable storage medium; and an internet gateway component that is coupled to a computer that comprises the computer-readable storage medium.

6. The computer-readable storage medium of claim 1, further comprising instructions which when executed cause receiving and storing a set of component associations, wherein each member of the set is any one of: Scanner-Printer: scan then print; Scanner-Printer: print list of scanned documents; TV-Printer: print electronic program guide; Camera-Web Site: transfer pictures to online web site; Camera-Printer: print list of images with thumbnails; Storage Component-Printer: print document from storage component.

7. A data processing device, comprising:
a network interface configured to couple to a network;
one or more processors coupled to the network interface;
a computer-readable storage medium coupled to the one or more processors and storing in combination sequences of instructions which when executed by the one or more processors cause:
receiving and storing a set of associations each identifying two or more data processing devices and one or more associated actions;
receiving a combination of an association and an action that can be performed on the association comprising a first data processing operation and a second data processing operation;
generating and sending, over the network, to a first device that implements the first data processing operation, a first request to perform the first data processing operation;
receiving result data from the first device;
generating and sending, over the network, to a second device that implements the second data processing operation, a second request to perform the second data processing operation using the result data.

8. The device of claim 7, wherein the instructions which when executed cause sending the first request and sending the second request each result in performing one or more of printing data, scanning data, transferring data over the network to a server, or transforming data from a first format to a second format.

9. The device of claim 7, further comprising sequences of instructions which when executed cause:
sending a discovery message to a network interface, wherein the discovery message identifies one or more service types, wherein the discovery message requests any components in the network to reply if the components support any of the one or more service types;
receiving one or more discovery response messages that indicate that one or more of the service types are implemented;
identifying one or more particular operations that are associated with the service types in the discovery response messages, and determining one or more available associations that identify actions that include the one or more particular operations;
generating output presenting a list of the available associations.

10. The device of claim 9, further comprising instructions which when executed cause generating a graphical user interface presenting the list of available associations, and updating the graphical user interface in response to receiving a completion message indicating completion of the second data processing operation.

11. The device of claim 7, further comprising instructions which when executed cause receiving the set of associations from any one of: a computer that comprises the computer-readable storage medium; a multifunction printer; a server that is coupled over a network to a computer that comprises the computer-readable storage medium; and an internet gateway device that is coupled to a computer that comprises the computer-readable storage medium.

12. The device of claim 7, further comprising instructions which when executed cause receiving and storing a set of device associations, wherein each member of the set is any one of: Scanner-Printer: scan then print; Scanner-Printer: print list of scanned documents; TV-Printer: print electronic program guide; Camera-Web Site: transfer pictures to online web site; Camera-Printer: print list of images with thumbnails; Storage Device-Printer: print document from storage device.

13. The device of claim 7, wherein the network interface comprises a cellular radio frequency transceiver configured to send and receive data to and from a cellular radiotelephone network.

14. A method, comprising in combination:
receiving and storing a set of associations each identifying a data processing action associated with two or more data processing operations;
receiving a combination of an association and an action that can be performed on the association comprising a first data processing operation and a second data processing operation;
generating and sending, over a network, to a first component that implements the first data processing operation, a first request to perform the first data processing operation;
receiving result data from the first component;
generating and sending, over the network, to a second component that implements the second data processing operation, a second request to perform the second data processing operation using the result data.

15. The method of claim 14, wherein sending the first request and sending the second request each result in performing one or more of printing data, scanning data, transferring data over the network to a server, or transforming data from a first format to a second format.

16. The method of claim 14, further comprising sequences of instructions which when executed cause:
sending a discovery message to a network interface, wherein the discovery message identifies one or more service types, wherein the discovery message requests any components in the network to reply if the components support any of the one or more service types;
receiving one or more discovery response messages that indicate that one or more of the service types are implemented;
identifying one or more particular operations that are associated with the service types in the discovery response messages, and determining one or more available associations that identify actions that include the one or more particular operations;
generating output presenting a list of the available associations.

17. The method of claim 16, further comprising instructions which when executed cause generating a graphical user interface presenting the list of available associations, and updating the graphical user interface in response to receiving a completion message indicating completion of the second data processing operation.

18. The method of claim 14, further comprising receiving the set of associations from any one of: a computer that comprises the method; a multifunction printer; a server that is coupled over a network to a computer that comprises the method; and an internet gateway component that is coupled to a computer that comprises the method.

19. The method of claim 14, further comprising instructions which when executed cause receiving and storing a set of component associations, wherein each of the component associations identifies two data processing units and an associated action, wherein each member of the set is any one of: Scanner-Printer: scan then print; Scanner-Printer: print list of scanned documents; TV-Printer: print electronic program guide; Camera-Web Site: transfer pictures to online web site; Camera-Printer: print list of images with thumbnails; Storage Component-Printer: print document from storage component.
